(19) United States
(12) Patent Application Publication
(10) Pub. No.: US 2026/0354382 A1
(43) Pub. Date: Nov. 12, 2026

(54) A STABLE NON-AQUEOUS AGROCHEMICAL FORMULATION

(71) Applicant: BASF SE, Ludwigshafen am Rhein (DE)

(72) Inventors: Wen XU, Durham, NC (US); Jessica Lee CANONICO, Durham, NC (US); Kara Walden BENTON, Durham, NC (US); Michael KRAPP, Alrtip (DE)

(21) Appl. No.: 19/130,694

(22) PCT Filed: Nov. 6, 2023
(86) PCT No.: PCT/EP2023/080748

§ 371 Date: May 16, 2025

(30) Foreign Application Priority Data
Nov. 16, 2022 (EP) 22207701.8

(51) Int. Cl. A01N 53/00; A01N 25/02; A01N 47/40; A01P 7/04

(52) U.S. Cl. CPC A01N 53/00; A01N 25/02; A01N 47/40; A01P 7/04

(57) ABSTRACT

A liquid formulation comprising
a. a non-aqueous water miscible solvent system S,
b. one or more pesticides in form of particles, which are suspended in the solvent system S,
wherein the solvent system S comprises a mixture of 1,2-propylene glycol and a C₄-C₈ glycol.

The invention relates to a non-aqueous liquid formulation comprising a water miscible solvent system S, one or more pesticides in form of particles, which are suspended in the solvent system S, wherein the solvent system S comprises a mixture of 1,2-propylene glycol and a C₄-C₈ glycol. It also relates to a spray liquid comprising such formulations. Further objects are nontherapeutic methods for controlling phytopathogenic fungi and/or undesired attack by insects or mites and/or for regulating the growth of plants where the formulation of the invention is allowed to act on the pests, their habitat or the plants to be protected from the particular pest, such as crop plants, the soil and/or on undesired plants and/or the useful plants, and/or their habitat.

Agrochemical formulations in form of non-aqueous suspensions are known and contain suspended pesticide particles in the liquid phase. Such suspension concentrates are particularly suitable if the suspended particles have a low solubility in water. Sometimes such non-aqueous suspension concentrates are also referred as to oil dispersions. Sometimes the term suspension in non-aqueous hydrophilic liquid (SNAHL) is used. Such SNAHL formulations have many benefits. For example, they provide good safety and user convenience due to their liquid character. However, these formulation types have various drawbacks, e.g. they often show long term stability issues, for example crystal growth due to Ostwald ripening. Hence, the right solvent system is essential to prevent crystal growth of the suspended pesticides. Finding a suitable solvent system is especially difficult when two or more pesticides are present since these will usually have different solubilities in different solvents. The object of the present invention was to overcome these problems by stabilizing a suspension concentration that comprise for example the pesticides Dinotefuran and alpha-Cypermethrin with a specific solvent system.

The objective has been achieved by a liquid formulation comprising
a) a non-aqueous water miscible solvent system S
b) one or more pesticides in form of particles, which are suspended in the solvent system S,
wherein the solvent system S comprises a mixture of 1,2-propylene glycol and a C₄-C₈ glycol.

Formulations of the invention are liquid at 20 °C. Formulations of the invention comprise a liquid phase and a suspended solid phase. The liquid phase is a non-aqueous phase and comprises a solvent system S. “Non-aqueous phase” as used herein means that the non-aqueous phase may contain not more than 10 wt % of water, preferably not more than 5 wt %, more preferably not more than 3 wt %, even more preferably not more than 1 wt % each time based on the total weight of the liquid phase.

Formulations of the invention comprise a water miscible solvent system S. When reference is made herein to the “solvent system S”, this shall mean a mixture of at least two solvents. It is understood that formulations of the invention comprise no solvents beyond solvent system S, it further being understood that surfactants are not considered solvents herein.

The term “water miscible” shall mean that the solvent system S has a solubility in water at 20 °C of at least 5 g/l, preferably of at least 20 g/l, more preferably at least 50 g/l, and in particular of at least 100 g/l.

The water miscible solvent system S comprises 1,2-propylene glycol. The terms “1,2-propylene glycol” and “propylene glycol” are herein used synonymously. Propylene glycol is water miscible.

The water miscible solvent system S comprises a C₄-C₈ glycol. Preferably, the C₄-C₈ glycol is a C₆-glycol. In one embodiment, said C₆-glycol is 2-methyl-2,4-pentanediol. The terms “2-methyl2,4-pentanediol” and “hexylene glycol” are herein used synonymously.

Formulations of the invention comprise a C₄-C₈ glycol and 1,2-propylene glycol in a mixture, wherein the ratio between said C₄-C₈ glycol to 1,2-propylene glycol may range from 10:1 to 1:5, preferably from 5:1 to 1:4, more preferably from 5:1 to 1:3, and in particular from 5:1 to 1:2.5 or from 3:1 to 1:2, where 10:1 means that ten parts of said C₄-C₈ glycol are mixed with one part of 1,2-propylene glycol. In one embodiment the ratio between C₄-C₈ glycol to 1,2-propylene glycol may range from 10:1 to 1:1, preferably from 5:1 to 1:1 and more preferably from 3:1 to 1:1, and in particular from 2.5:1 to 1:1.

In one embodiment, formulations of the invention comprise 2-methyl-2,4-pentanediol and 1,2-propylene glycol in a mixture, wherein the ratio between 2-methyl-2,4-pentanediol to 1,2-propylene glycol may range from 10:1 to 1:5, preferably from 5:1 to 1:4, more preferably from 5:1 to 1:3, and in particular from 5:1 to 1:2.5 or from 3:1 to 1:2. In one embodiment the ratio between 2-methyl-2,4-pentanediol to 1,2-propylene glycol may range from 10:1 to 1:1, preferably from 5:1 to 1:1 and more preferably from 3:1 to 1:1, and in particular from 2.5:1 to 1:1.

Formulations of the invention comprise 1,2-propylene glycol, wherein the concentration of 1,2-propylene glycol may range 5 to 45 wt %, preferably from 10 to 40 wt % and more preferably from 15 to 35 wt %, each time based on the total weight of the formulation.

In one embodiment the water miscible solvent system S comprises 1,2-propylene glycol and C₄-C₈ glycol, especially 2-methyl-2,4-pentanediol, and no further solvents. In one embodiment the water miscible solvent system S comprises 1,2-propylene glycol, C₄-C₈ glycol, especially 2-methyl-2,4-pentanediol, and further solvents. When reference is made herein to “further solvents”, this shall mean solvents different from 1,2-propylene glycol and C₄-C₈ glycol, especially 2-methyl-2,4-pentanediol.

The solvent system S typically comprises 70 to 100 wt % of the mixture of 1,2-propylene glycol and 2-methyl-2,4-pentanediol and in particular 80 to 100 wt %, based on the total weight of the solvent system S. In another embodiment the solvent system S comprises 100 wt % of the mixture of 1,2-propylene glycol and 2-methyl-2,4-pentanediol, based on the total weight of the solvent system S. In another embodiment the solvent system S comprises at least 90 wt %, preferably at least 80%, more preferably at least 70% of the mixture of 1,2-propylene glycol and 2-methyl-2,4-pentanediol, based on the total weight of the solvent system S.

Formulations of the invention comprise a solvent system S, wherein the total amount of solvent system S typically ranges from 30 to 80 wt %, preferably from 40 to 70 wt %, based on the total weight of the formulation. In one embodiment solvent system S makes up 50 to 60 wt %, each time based on the total weight of the formulation. In one embodiment the amount of solvent system S ranges from 20 to 90 wt %, preferably from 25 to 85 wt % and more preferably from 35 to 75 wt %, each time based on the total weight of the formulation.

The water miscible solvent system S may comprise further solvents. Such further solvents are normally selected so that solvent system S is a homogenous solution at 20 °C. Suitable further solvents include: ethylene glycol, polyethylene glycol, polypropylene glycol, glycerin, propylene carbonate, ethylene carbonate, butylene carbonate, dimethyl sulfoxide, diacetone alcohol (2-methyl-4-oxo-pentane-2-ol), n-pentanol, n-hexanol, n-heptanol, n-octanol, 2-ethyl-hexanol, cyclohexanol, dipropylene glycol, diethylene glycol monomethyl ether, dipropylene glycol monomethyl ether, isobutanol, benzyl alcohol.

The solid phase comprises solid particles which are suspended in the liquid phase. The solid phase comprises pesticide particles that are insoluble in the solvent system S. “Insoluble” pesticides typically have a solubility in water and in the solvent system S at 20 °C and at pH 7 of up to 10 g/l, preferably of up to 1 g/l, more preferably of up to 0.1 g/l and even more preferably of up to 0.01 g/l.

Formulations of the invention comprise one or more pesticides. Pesticides may be selected from the group of fungicides, insecticides, nematicides, herbicides, safeners, nitrification inhibitors, urease inhibitors, plant growth regulators, micronutrients, biopesticides and/or growth regulators.

The pesticides are present in the form of suspended particles in formulations of the invention. The particles may be characterized by their size distribution, which can be determined by dynamic light scattering techniques. Suitable dynamic light scattering measurement units are inter alia produced under the trade name Malvern Mastersizer 3000. The particles may be characterized by their median diameter, which is usually abbreviated as D50 value. The D50 value refers to a particular particle diameter, wherein half of the particle population by volume is smaller than this diameter. The D50 value is typically determined according to ISO 13320:2009.

The particles of the pesticides typically have an D50 value from 0.05 μm to 30 μm, preferably from 0.1 μm to 20 μm, more preferably from 0.5 to 20 μm, even more preferably from 0.5 μm to 15 μm, especially preferably from 0.5 μm to 10 μm. The particles typically have an D50 value of at least 0.75 μm and preferably at least 1 μm. The suspended particles may be present in the form of crystalline or amorphous particles which are solid at 20 °C.

In one embodiment, the pesticide is an insecticide, preferably one or more of the group consisting pyrethroids or nitroguanidine derivatives. In another embodiment, the pesticide is a herbicide. In another embodiment, the pesticide is a fungicide.

The skilled worker is familiar with such pesticides, which can be found, for example, in the Pesticide Manual, 16th Ed. (2013), The British Crop Protection Council, London. Suitable insecticides are insecticides from the class of the carbamates, organophosphates, organochlorine insecticides, phenylpyrazoles, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, pyrethroids, tetradifon, chlorofenapyr, DNOC, buprofezine, cyromazine, amitraz, hydramethylnon, acequinocyl, fluacrypyrim, rotenone, or their derivatives. Suitable fungicides are fungicides from the classes of dinitroanilines, allylamines, anilinopyrimidines, antibiotics, aromatic hydrocarbons, benzanilides, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridinium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, thetrazolinones, thiadiazoles, thiocarbamates, triazines, triazinones, triazoles, triazolinones, triazolocarboxamides, triazolopyrimidines, triketones, uracils, ureas.

In one embodiment the pesticide is Dinotefuran or alpha-Cypermethrin or a mixture thereof. In one embodiment, formulations of the invention comprise from 0.1 to 50 wt %, preferably from 5 to 40 wt %, and in particular from 14 to 30 wt % of alpha-Cypermethrin, based on the total weight of the formulation.

In one embodiment, formulations of the invention comprise from 0.1 to 40 wt %, preferably from 5 to 30 wt %, and in particular from 10 to 18 wt % of Dinotefuran, based on the total weight of the formulation.

In one embodiment, formulations of the invention comprise from 0.1 to 50 wt % of alpha-Cypermethrin and 0.1 to 40 wt % of dinotefurane, preferably from 5 to 40 wt % of alpha-Cypermethrin and 5 to 30 wt % of dinotefurane, and in particular from 14 to 30 wt % of alpha-Cypermethrin and 10 to 18 wt % of Dinotefuran, each case based on the total weight of the formulation.

In one embodiment, formulations of the invention further comprise a polyalkylene oxide block copolymer, herein also referred to as polyalkylene oxide copolymer A. The block copolymer can, for example be a diblock polymer or a triblock copolymer. In one embodiment, the blocks of the block copolymer are of the A-B or A-B-A type. Typically, the block copolymer is a nonionic dispersant. The block copolymer is preferably an alkoxylate block copolymer, which may comprise blocks of polyethylene oxide and polypropylene oxide.

The block copolymer is preferably an alkoxylate block copolymer, which preferably comprises blocks of polyethylene oxide and polypropylene oxide. The alkoxylate block copolymers comprise usually at least 20 wt %, preferably at least 30 wt % of polymerized ethylene oxide. In a preferred form the alkoxylate block copolymers comprise at least 10 wt %, preferably at least 15 wt % of polymerized ethylene oxide. In one embodiment, alkoxylate block copolymers are preferably a block polymer A-B-A type comprising blocks of polyethylene oxide (block “A”) and polypropylene oxide (block “B”). In one embodiment, alkoxylate block copolymers are preferably a block polymer A-B type comprising blocks of polyethylene oxide (block “A”) and polypropylene oxide (block “B”). In one embodiment the alkoxylate block copolymers are terminated on both ends by hydroxyl groups. In one embodiment the alkoxylate block copolymers are terminated on one end by an alkyl group. In one embodiment the alkoxylate block copolymers are terminated on one end by a C₁ to C₁₈-alkyl group. In one embodiment the alkoxylate block copolymers are terminated on one end by a C₁ to C₈-alkyl group. In one embodiment the alkoxylate block copolymers are terminated on one end by a n-butyl group. In one embodiment the alkoxylate block copolymers are terminated on one end by a mono(4-butoxybutyl) ether group.

In one embodiment the alkoxylate block copolymers are block copolymers of ethylene oxide (“EO”) and propylene oxide (“PO”) that are terminated on one end by an alkyl group. In one embodiment the alkoxylate block copolymers are block copolymers of EO and PO that are terminated on one end by a C₁ to C₁₈-alkyl group. In one embodiment the alkoxylate block copolymers are block copolymers of EO and PO that are terminated on one end by a C₁ to C₈-alkyl group. In one embodiment the alkoxylate block copolymers are block copolymers of EO and PO that are terminated on one end by a n-butyl group or a mono(4-butoxybutyl) ether group.

In one embodiment the alkoxylate block copolymers are diblock copolymers of EO and PO that are terminated on the PO block by an alkyl group. In one embodiment the alkoxylate block copolymers are diblock copolymers of EO and PO that are terminated on the PO block by a C₁ to C₁₈-alkyl group. In one embodiment the alkoxylate block copolymers are diblock copolymers of EO and PO that are terminated on the PO block by a C₁ to C₈-alkyl group. In one embodiment the alkoxylate block copolymers are diblock copolymers of EO and PO that are terminated on the PO block by an n-butyl group or a mono(4-butoxybutyl) ether group.

Formulations of the invention typically comprise a polyalkylene oxide copolymer with a HLB in the range of 14 to 20, more preferably from 16 to 18. In one embodiment the polyalkylene oxide copolymer has a HLB value in the range of 16.5 to 17.5.

In one embodiment, formulations of the invention comprise a polyalkylene oxide diblock copolymer that is a nonionic alcohol alkoxylate comprising block of ethylene oxide and propylene oxide with a HLB of 17 of 16 to 18.

In one embodiment, formulations of the invention comprise a polyalkylene oxide diblock copolymer that is a nonionic alcohol alkoxylate comprising a terminal butyl group and blocks of ethylene oxide and propylene oxide with a HLB of 17 of 16 to 18.

In one embodiment, formulations of the invention comprise a polyalkylene oxide diblock copolymer that is a nonionic alcohol alkoxylate comprising a terminal mono(4-butoxybutyl) ether group and blocks of ethylene oxide and propylene oxide with a HLB of 17 of 16 to 18.

Typically, formulations of the invention comprise from 0.1 to 10 wt %, preferably from 1 to 7 wt %, and in particular from 1 to 5 wt % of polyalkylene oxide copolymer, based on the total weight of the formulation.

In one embodiment, formulations of the invention comprise a naphthalene sulfonate. The term naphthalene sulfonate shall include mono naphthalene sulfonates as well as condensation products of naphthalene sulfonates with formaldehyde. In each case, the naphthalene moieties may contain further substituents such as alkyl groups on the aromatic moiety.

In one embodiment said naphthalene sulfonate is 1-naphthalene sulfonate, 2-naphthalene sulfonate or a mixture thereof.

In one embodiment, said naphthalene sulfonate is the condensation product of a naphthalene sulfonate with formaldehyde, especially the condensation product of 1-naphthalene sulfonate, 2-naphthalene sulfonate or a mixture thereof with formaldehyde

In one embodiment, said condensation product of a naphthalene sulfonate with formaldehyde comprises a number average of 1.5 to 10, preferably 2 to 3 naphthalene moieties per molecule.

Typically, formulations of the invention comprise from 0.1 to 10 wt %, preferably from 1 to 8 wt %, and in particular from 1.5 to 6.5 wt % of the naphthalene sulfonate, based on the total weight of the formulation.

In one embodiment formulations of the invention comprise one or more thickener. In one embodiment, the thickener is hydrophilic fumed silica, preferably hydrophilic fumed silica particles. In another embodiment, the thickener is a clay.

In one embodiment, the thickener is present in dissolved form in the liquid phase. In another embodiment, the thickener may be present in the form of particles.

Formulations of the invention typically comprise the thickener in a concentration of at least 0.1 wt %, preferably at least 0.5 wt % based on the total weight of the formulation. Formulations of the invention typically comprise the thickener in a concentration of up to 5 wt %, preferably up to 2 wt % based on the total weight of the formulation. In one embodiment, formulations of the invention comprise the thickener in a concentration range from 0.1 to 10 wt %, preferably from 0.5 to 5 wt %, more preferably from 0.8 to 2 wt % based on the total weight of the formulation.

Formulations of the invention may contain a wide variety of auxiliaries. Suitable auxiliaries include further surfactants different from block polymers, dispersants, emulsifiers, wetters (also referred as wetting agents), adjuvants, solubilizers, penetration enhancers, protective colloids, adhesion agents, humectants, repellents, attractants, feeding stimulants, compatibilizers, bactericides, anti-freezing agents, anti-foaming agents, colorants, tackifiers and binders.

Suitable further surfactants include surface-active compounds different from a polyalkylene oxide copolymer A and a naphthalenesulfonate formaldehyde condensate, such as anionic, cationic, non-ionic and amphoteric surfactants and polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants include alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl naphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants include alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide.

Examples of N-substituted-fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants include quaternary surfactants, for example quaternary ammonium compounds with one or two hydrophobic groups, or salts of long-chain primary amines. Suitable amphoteric surfactants are alkylbetains and imidazolines.

Suitable adjuvants include compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable bactericides include bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g. in red, blue, or green) are pigments of low water solubility and water soluble dyes. Examples are inorganic colorants (e.g. iron oxide, titan oxide, iron hexacyanoferrate) and organic colorants (e.g. alizarin-, azo- and phthalocyanine colorants). Suitable tackifiers or binders are polyvinylpyrrolidones, polyvinylacetates, polyvinyl alcohols, polyacrylates, biological or synthetic waxes, and cellulose ethers.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 10:1 to 1:5.

In one embodiment, formulations of the invention comprise
a) 25 to 85 wt % of a water miscible solvent system S, based on the total weight of the formulation;
b) 5 to 40 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol to ranges from 5:1 to 1:4.

In one embodiment, formulations of the invention comprise
a) 35 to 75 wt % of a water miscible solvent system S, based on the total weight of the formulation;
b) 14 to 30 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:3.

In one embodiment, formulations of the invention comprise
a) 35 to 75 wt % of a water miscible solvent system S, based on the total weight of the formulation;
b) 14 to 30 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:2.5.

In one embodiment, formulations of the invention comprise
a) 20 to 90 wt % of a water miscible solvent system S, based on the total weight of the formulation;
b) 0.1 to 50 wt % of a mixture of alpha-cypermethrin and dinotefurane in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 10:1 to 1:5.

In one embodiment, formulations of the invention comprise
a) 20 to 90 wt % of a water miscible solvent system S, based on the total weight of the formulation;
b) 10 to 30 wt % of alpha-cypermethrin and 5 to 25 wt % of dinotefurane in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to1,2-propylene glycol ranges from 5:1 to 1:10.

In one embodiment, formulations of the invention comprise
a) 20 to 90 wt % of a water miscible solvent system S, based on the total weight of the formulation;
b) 20 to 24 wt % of alpha-cypermethrin and 12 to 16 wt % of dinotefurane in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:10.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:4

In one embodiment, formulations of the invention comprise
a) 20 to 90 wt % of a water miscible solvent system S, based on the total weight of the formulation;

b) 0.1 to 50 wt % of one or more pesticides in form of particles, which are suspended in the solvent system S, based on the total weight of the formulation;

wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:3.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:2.5.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 3:1 to 1:2.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 10:1 to 1:1.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 5:1 to 1:1.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of C₄-C₈ glycol to 1,2-propylene glycol ranges from 3:1 to 1:1.

In one embodiment, formulations of the invention comprise
a) 20 to 90 wt % of a water miscible solvent system S, based on the total weight of the formulation;
b) 0.1 to 50 wt % of one or more pesticides in form of particles, which are suspended in the solvent system S, based on the total weight of the formulation;
wherein the solvent system S comprises a mixture of 1,2-propylene glycol and a C₄-C₈ glycol, especially hexylene glycol, wherein the ratio of to C₄-C₈ glycol to 1,2-propylene glycol ranges from 2.5:1 to 1:1.

Another embodiment of the present invention are processes for making formulations of the invention. Typically, formulations of the invention are prepared in a process, where the one or more pesticide, the water miscible solvent system S and optionally the polyalkylene oxide block copolymer A and a naphthalene sulfonate condensate are contacted. The contacting of the components can be done in any order.

In one embodiment the process for making formulations of the invention comprises following steps:
A. Contacting the components of solvent system S and optionally surfactants until homogeneous.
B. Adding solid pesticides that are insoluble in the solvent system S, for example Dinotefuran and alpha-Cypermethrin, to the mixture and homogenizing until homogenous.
C. Milling the mixture obtained in steps A. to B., for example in a wet bead mill until a mean particle size of pesticides typically have a value from 0.05 μm to 30 μm.

In one embodiment a fumed silica thickener is mixed into the formulation with A., B., and C. until homogenous.

In one embodiment, formulations of the invention are diluted with water before application to obtain a spray liquid, also referred to as spray solution or tank mix.

The tank mix comprises the formulation at a concentration of from 1 to 99.9 wt %, preferably of from 5 to 99 wt %, more preferably of from 5 to 95 wt %, most preferably of from 20 to 80 wt % based on the total weight of the tank mix. The tank mix may comprise at least 30 wt % of the formulation of the invention, preferably at least 50 wt %, more preferably at least 90 wt % of the formulation based on the total weight of the tank mix. The tank mix typically comprises up to 99.9 wt % of the formulation of the invention based on the total weight of the tank mix, preferably up to 95 wt %, more preferably up to 90 wt %.

In one embodiment formulations of the invention are mixed with fertilizers in the tank mix. Such fertilizers are typically inorganic and are used to enhance plant growth.

The weight ratio of the formulation according to the invention to the inorganic fertilizer in the tank mix may vary in broad ranges, such as from 100:1 to 1:100, preferably from 98:2 to 2:98, most preferably from 95:1 to 1:95.

The tank mix may be prepared by contacting the formulations of the invention, and the inorganic fertilizer, and optionally water in any suitable order. The contacting is typically achieved by mixing the components in a tank.

The tank mix may further contain auxiliaries as specified above for the formulations of the invention. Typically, the tank mix may also contain further agrochemical actives, such as pesticides and fertilizers.

Another embodiment of the invention are non-therapeutic methods for controlling phytopathogenic fungi and/or undesired attack by insects or mites and/or for regulating the growth of plants where the formulation of the invention is allowed to act on the pests, their habitat or the plants to be protected from the particular pest, the soil and/or on undesired plants and/or useful plants and/or their environment. In one embodiment the plants to be protected are crop plants.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants. In one embodiment the crop plant to be protected may be soybean.

The invention also relates to the use of the solvent system S, wherein the solvent system S comprises a mixture of 1,2-propylene glycol and a C₄-C₈ glycol, for inhibiting the crystal growth of particles of Dinotefuran or alpha-Cypermethrin or a mixture thereof. Such solvent system S is typically used in the formulation in the amount of 30 to 80 wt %, preferably of 40 to 70 wt %, based on the weight of the total weight of the formulation. The inhibition of crystal growth of a formulation with suspended pesticide particles can be measured by comparing a formulation to which the solvent system S has been added as compared to a formulation from the art. After 4 weeks at 40 °C for example, the crystal growth in a liquid formulation is determined by suitable light scattering measurements, as described above, or other suitable methods, e.g. visual inspection/microscopy

Advantages of the present invention are, inter alia, that formulations of the invention have a high storage stability, even at elevated temperatures or under alternating temperatures. The advantages of present invention include that a high storage stability is achieved even at high pesticide loadings and despite the fact that one or more pesticides are present in the formulation as suspended particles

Further advantages are
the particle size growth of dispersed agrochemical active substances is slowed down or suppressed
crystal growth of dispersed agrochemical particles is slowed down or suppressed
the agglomeration of dispersed agrochemical particles is slowed down or suppressed
the settling of dispersed agrochemical active substances is slowed down or suppressed
the abovementioned advantages are also attained in the presence of high salt concentrations
formulations of the invention are easy and economical to make
formulations of the invention have high biological activity
formulations of the invention are environmentally friendly
formulations of the invention suppress pesticidal resistance
formulations of the invention are sustainable
formulations of the invention are easy to use
formulations of the invention are compatible with a plurality of further pesticides or other additives like fertilizers.

The examples which follow illustrate the invention without imposing any limitation.

### EXAMPLES

Materials are used:
Pesticide A: Alpha-Cypermethrin
Pesticide B: Dinotefuran
Stabilizer 1: Citric Acid
Surfactant 1: Nonionic alkoxylate comprising blocks of ethylene oxide and propylene oxide and a terminal n-butyl group with a HLB of 17.
Surfactant 2: Tristyrylphenol ethoxylate with an ethoxylation degree of 10
Surfactant 3: Ethoxylated castor oil with an ethoxylation degree of 10
Surfactant 4: Ethoxylated castor oil with an ethoxylation degree of 20
Surfactant 5:12-hydroxystearic acid polyethylene glycol copolymer with a HLB of 6
Surfactant 6: Methyl methacrylate graft copolymer with a HLB of 12
Surfactant 7: Mixture of a naphthalenesulfonate formaldehyde condensate and a copolymer
Surfactant 8: Naphthalenesulfonate formaldehyde condensate
Surfactant 9: Nonionic surfactant with a degree of ethoxylation in the range of 4 to 6 and a hydroxyl number in the range from 125 to 135 calculated by the method of DIN 53240
Thickener 1: Hydrophilic fumed silica with a surface area of 200 m²/g
Solvent 1:1,2-Propylene glycol
Solvent 2:2-Methyl-2,4-pentadiol

### Example-1: Screening of Concentration Ratio of Different Solvents

A SNAHL formulation containing both Dinotefuran and alpha-Cypermethrin was prepared with two solvents, a fumed silica thickener, and a surfactant system as shown in tables A and B to evaluate the ability of the surfactant system to inhibit Dinotefuran and alpha-Cypermethrin crystal growth.

Formulations comprising alpha-Cypermethrin and Dinotefuran were prepared with ingredients specified in Table A, wherein different concentration ratios of solvent 1 and 2 were added to the formulation according to Table B.

The formulations were prepared by mixing the two solvents and surfactant system together until homogeneous. Then the fumed silica thickener was mixed into the solution until homogeneous. Finally, Dinotefuran and alpha-Cypermethrin were added to the mixture and homogenized until homogeneous. The formulation was then milled in a wet bead mill until a mean particle size of 2-3 microns was achieved.

The initial viscosity of the formulation was measured using an Anton Paar Rheometer at 20 °C with a 200 s⁻¹ pre shear and data collection every 10 s at 100 s⁻¹ then averaged. A low viscosity is desirable.

The samples were stored in a 40 °C chamber for up to 4 weeks and the surfactant system's ability to inhibit crystal growth of both active ingredients was determined by visual inspection after storage.

The various concentrations used, and the results are summarized in the below Table B.

TABLE A
Ingredients of the SNAHL1 to SNAHL6, wherein the concentration
ratio of the solvent 1 and 2 was varied according to Table B.

| SNAHL formulation | Concentration [wt %] |
|---|---|
| Pesticide A | 22.00 |
| Pesticide B | 14.00 |
| Stabilizer 1 | 0.20 |
| Surfactant 1 | 4.00 |
| Surfactant 7 | 4.00 |
| Surfactant 9 | 1.00 |
| Thickener 1 | 0.20 |
| Solvent 1 | 0.0-54.60 |
| Solvent 2 | Add up to 100 |

TABLE 1B
Screened concentration ratios of solvent 1 and 2 in SNAHL
formulations and results regarding viscosity and crystal
growth (5- most crystal growth 1- no crystal growth).

| | | | | | Pesticide | Pesticide |
|---|---|---|---|---|---|---|
| | | | Solvent | | B crystal | A crystal |
| | | | 2:solvent | | growth at | growth at |
| SNAHL | Solvent 2 | Solvent 1 | 1 | Viscosity | 4 weeks | 4 weeks at |
| # | [wt %] | [wt %] | ratio | [mPa/s] | at 40 °C | 40 °C |
| 1^{a)} | 0 | 54.60 | 0:1 | 610 | 5 | 5 |
| 2 | 13.65 | 40.95 | 1:3 | 880 | 4 | 5 |
| 3 | 18.02 | 36.58 | 1:2 | 840 | 3 | 2 |
| 4 | 27.30 | 27.30 | 1:1 | 498 | 2 | 2 |
| 5 | 36.60 | 18.00 | 2:1 | 598 | 1 | 1 |
| 6^{a)} | 54.60 | 0.00 | 1:0 | 510 | 1 | 5 |

^{a)}Not according to invention.

With a concentration ratio of 2:1 of solvent 2 to solvent 1 the crystal growth was significantly decreased at an initial timepoint and after 4 weeks.

### Example-2: Screening of Surfactants

SNAHL formulations containing both Dinotefuran and alpha-Cypermethrin were prepared with solvent 1 and 2, fumed silica thickener, and a surfactant system (various surfactants) to evaluate the ability of the surfactant system to inhibit Dinotefuran crystal growth.

A formulation comprising alpha-Cypermethrin and Dinotefuran were prepared with ingredients specified in Table A, wherein different surfactants were added to the formulation according to Table B.

TABLE 2A
Ingredients of formulations SNAHL7 to SNAHL13, wherein
the surfactants were varied according to Table B.

| SNAHL formulation | Concentration [wt %] |
|---|---|
| Pesticide A | 22.00 |
| Pesticide B | 14.00 |
| Stabilizer 1 | 0.20 |
| Surfactant 1 | 4.00 |
| Surfactant | 4.00 |
| Surfactant 9 | 1.00 |
| Thickener 1 | 0.20 |
| Solvent 1 | 18 |
| Solvent 2 | Add up to 100 |

TABLE 2B
Screened surfactants formulations SNAHL7 to SNAHL13.

| SNAHL # | Surfactant # | Viscosity [mPa/s] |
|---|---|---|
| 7 | 2 | >600 |
| 8 | 3 | >600 |
| 9 | 4 | >600 |
| 10 | 5 | >600 |
| 11 | 7 | <600 |
| 12 | 8 | <600 |
| 13 | none | >600 |

SNAHL11 and SNAHL12 had a significantly more acceptable viscosity (<600 mPa/s) compared to the formulation without a surfactant and compared to the other tested formulations.

### Example-3: Effect of Surfactant 7 Concentration on Crystal Growth Reduction and Viscosity Modification

SNAHL formulations containing both Dinotefuran and alpha-Cypermethrin were prepared with solvent 1 and 2, fumed silica thickener, and a surfactant system (various surfactants) to evaluate the ability of various concentrations of surfactant 7 to inhibit Dinotefuran crystal growth and the effect on viscosity.

The formulation was prepared by mixing the solvent 1 and 2 and surfactant system together until homogeneous. Then the fumed silica thickener was mixed into the solution until homogeneous. Finally, Dinotefuran and alpha-Cypermethrin were added to the mixture and homogenized until homogeneous. The formulation was then milled in a wet bead mill until a mean particle size of 2-3 microns was achieved.

TABLE 3A
Ingredients of SNAHL9 to SNAHL13

| SNAHL formulation | Concentration [wt %] |
|---|---|
| Pesticide A | 22.00 |
| Pesticide B | 14.00 |
| Stabilizer 1 | 0.20 |
| Surfactant 1 | 4.00 |
| Surfactant 7 | 0.00-8.00 |
| Surfactant 9 | 1.00 |
| Thickener 1 | 0.20 |
| Solvent 1 | 18 |
| Solvent 2 | Add up to 100 |

The samples were prepared where the concentration of the surfactant 7 was varied from 0-8% by weight. The viscosity was measured using an Anton Paar Rheometer at 20 °C with a 200 s⁻¹ pre shear and data collection every 10 s at 100 s⁻¹ then averaged. A low viscosity is desirable.

The samples were stored in a 40 °C chamber for up to 4 weeks to determine the surfactant system's ability to inhibit crystal growth.

TABLE 3B

| | | | Pesticide | Pesticide |
|---|---|---|---|---|
| | | | B Crystal | A Crystal |
| | | | growth at | growth at |
| SNAHL | Surfactant 7 | Viscosity | 40 °C over | 40 °C over |
| # | [wt %] | [mPa/s] | 4 weeks | 4 weeks |
| 9 | 0.00 | 1289 | 1 | 5 |
| 10 | 2.00 | 587 | 5 | 2 |
| 11 | 4.00 | 498 | 2 | 2 |
| 12 | 6.00 | 588 | 2 | 1 |
| 13 | 8.00 | 744 | 3 | 1 |

Screening of concentration of surfactant 7 in SNAHL9 to SNAHL13 and the achieved results of viscosity and crystal growth (5-most crystal growth 1-no crystal growth).

### Example-4: Effect of Surfactant Combination on Crystal Growth in the SNAHL Formulation

The SNAHL formulation containing both Dinotefuran and alpha-Cypermethrin were prepared with solvent 1 and 2, fumed silica thickener, and various surfactant systems to evaluate the ability of the surfactant system to inhibit Dinotefuran crystal growth.

The formulations were prepared by mixing solvent 1 and 2 and surfactant system together until homogeneous. Then the fumed silica thickener was mixed into the solution until homogeneous. Finally, Dinotefuran and alpha-Cypermethrin were added to the mixture and homogenized until homogeneous. The formulation was then milled in a bead mill until a mean particle size of 2-3 microns was achieved.

TABLE 4A
Ingredients of SNAHL14 to SNAHL20, wherein the combination
of surfactants is listed in Table B.

| SNAHL formulation | Concentration [wt %] |
|---|---|
| Pesticide 1 | 22.00 |
| Pesticide 2 | 14.00 |
| Stabilizer 1 | 0.20 |
| Surfactant 1 | 4.00 |
| Surfactant 2, 3, 4, 5, 6 or 7 | 4.00 |
| Surfactant 9 | 1.00 |
| Thickener 1 | 0.20 |
| Solvent 1 | 18 |
| Solvent 2 | Add up to 100 |

The samples were stored in a 40 °C chamber for up to 4 weeks to determine the surfactant system's ability to inhibit crystal growth.

TABLE 4B
Combination of surfactants in SNAHL14 to SNAHL20
and the achieved results of crystal growth (5-
most crystal growth, 1- no crystal growth).

| | | | Crystal Growth after |
|---|---|---|---|
| | | | storage at 40 °C for |
| SNAHL # | Surfactant # | Surfactant # | up to 4 weeks |
| 14 | 1 | 2 | 5 |
| 15 | 1 | 3 | 5 |
| 16 | 1 | 4 | 5 |
| 17 | 1 | 5 | 5 |
| 18 | 1 | 6 | 5 |
| 19^{a)} | 1 | 7 | 1 |
| 20 | 1 | none | 5 |

^{a)}according to the invention

The results showed that the formulation with the combination of surfactant 1 with surfactant 7 showed the best results with respect to crystal growth after storage in the 40 °C chamber.

1. A liquid formulation comprising
a. a non-aqueous water miscible solvent system S, and
b. one or more pesticides in form of particles, which are suspended in the solvent system S,
wherein the solvent system S comprises a mixture of 1,2-propylene glycol and a C₄-C₈ glycol.

2. The formulation according to claim 1, wherein the liquid formulation comprises two or more pesticides.

3. The formulation according to claim 1, wherein said one or more pesticides comprise a mixture of alpha-Cypermethrin and Dinotefuran.

4. The formulation according to claim 1, wherein said C₄-C₈ glycol is 2-Methyl-2,4-pentanediol.

5. The formulation according to claim 4, wherein the weight ratio of 2-Methyl-2,4-pentanediol to 1,2-propylene glycol is from 10:1 to 1:5.

6. The formulation according to claim 1, wherein the concentration of 1,2-propylene glycol in the formulation ranges from 5 to 45 wt %.

7. The formulation according to claim 1, wherein the formulation comprises a polyalkylene oxide block copolymer A.

8. The formulation according to claim 7, wherein the concentration of said polyalkylene oxide block copolymer A is up to 10 wt % based on the formulation.

9. The formulation according to claim 7, wherein said polyalkylene oxide block copolymer A has an HLB value in the range from 14 to 20.

10. The formulation according to claim 7, wherein said polyalkylene oxide block copolymer A is a block copolymer of ethylene oxide and propylene oxide.

11. The formulation according to claim 1, wherein the formulation comprises naphthalene sulfonate condensates.

12. The formulation according to claim 11, wherein the concentration of said naphthalene sulfonate condensate is up to 10 wt % based on the formulation.

13. A method for the preparation of the formulation in claim 1, comprising contacting the one or more pesticides, the water miscible solvent system S, and optionally polyalkylene oxide block copolymer A and optionally naphthalene sulfonate condensate.

14. A method for controlling phytopathogenic fungi and/or undesired plant growth and/or undesired attack by insects or mites and/or regulating the growth of plants, comprising allowing the formulation of claim 1 to act on phytopathogenic fungi, their habitat or the plants to be protected from phytopathogenic fungi, soil and/or on undesired plants and/or useful plants and/or their habitat.
